(19) United States
(12) Patent Application Publication
(10) Pub. No.: US 2025/0349088 A1
(43) Pub. Date: Nov. 13, 2025

(54) POSE CONTROL METHOD FOR EXTENDED REALITY, ELECTRONIC DEVICE, AND STORAGE MEDIUM

(71) Applicant: Beijing Zitiao Network Technology Co., Ltd., Beijing (CN)

(72) Inventors: Jiqin DU, Beijing (CN); Ruisheng ZHANG, Beijing (CN)

(21) Appl. No.: 19/201,319

(22) Filed: May 7, 2025

(30) Foreign Application Priority Data
May 11, 2024 (CN) 202410585682.0

(51) Int. Cl. G06T 19/00; G06F 3/01

(52) U.S. Cl. CPC G06T 19/006; G06F 3/011

(57) ABSTRACT

Embodiments of the present disclosure provide a pose control method for extended reality, an electronic device, and a storage medium. The method is performed by a computer device in communication with an extended reality device, and the method includes: receiving pose data of a user and a pose event corresponding to the pose data sent by the extended reality device; updating a virtual object in an extended reality scene based on the pose data; and causing a target application running on the computer device to perform a response corresponding to the pose event, where real-time images of the target application are transmitted by the computer device to the extended reality device.

### CROSS-REFERENCE TO RELATED APPLICATION

This application claims the priority to and benefits of the Chinese Patent Application, No. 202410585682.0, which was filed on May 11, 2024. All the aforementioned patent applications are hereby incorporated by reference in their entireties.

### TECHNICAL FIELD

The present disclosure relates to the field of computer technologies and, in particular, to a pose control method for extended reality, an electronic device, and a storage medium.

### BACKGROUND

Extended reality streaming, also known as X R streaming (Extended Reality Streaming) technology, allows the contents of virtual reality (VR), augmented reality (AR) or mixed reality (MR), including real-time images, interactive data, etc., to be transmitted from a computer (such as a personal computer or a cloud server) to a user's X R headset for display and interaction, while the actual rendering and data processing work is mainly done by the computer. This makes the user's extended reality experience no longer limited by the processing power and storage space of the X R headset itself, and the user can experience extended reality content that originally required a high-performance computer to run on a lightweight X R device without high-end hardware. However, there is currently a lack of a gesture interaction solution that can be better adapted to X R streaming application scenarios.

### SUMMARY

The Summary is provided to introduce concepts in a simplified form that are described in detail in the following Detailed Description section. The Summary is not intended to identify key features or essential features of the claimed technical solutions, nor is it intended to be used to limit the scope of the claimed technical solutions.

At least one embodiment of the present disclosure provides a pose control method for extended reality, which is performed by a computer device in communication with an extended reality device, and the method includes:
receiving pose data of a user and a pose event corresponding to the pose data sent by the extended reality device;
updating a virtual object in an extended reality scene based on the pose data; and
causing a target application running on the computer device to perform a response corresponding to the pose event, where real-time images of the target application are transmitted by the computer device to the extended reality device.

At least one embodiment of the present disclosure provides a pose control method for extended reality, which is performed by a computer device in communication with an extended reality device, and the method includes:
acquiring pose data detected by a sensor;
determining a pose event based on the pose data;
performing serialization processing on the pose data and the pose event; and
transmitting the pose data and the pose event that are subjected to the serialization processing to the computer device, to cause the computer device to update a virtual object in an extended reality scene based on the pose data and cause a target application running on the computer device to perform a response corresponding to the pose data, where real-time images of the target application are transmitted by the computer device to the extended reality device.

At least one embodiment of the present disclosure provides a pose control apparatus for extended reality, and the apparatus includes:
a pose receiving unit configured to receive pose data of a user and a pose event corresponding to the pose data sent by an extended reality device;
an object updating unit configured to update a virtual object in an extended reality scene based on the pose data; and
an event processing unit configured to cause a target application running on a computer device to perform a response corresponding to the pose event, where real-time images of the target application are transmitted by the computer device to the extended reality device.

At least one embodiment of the present disclosure provides a pose control apparatus for extended reality, and the apparatus includes:
a pose acquiring unit configured to acquire pose data detected by a sensor;
an event determining unit configured to determine a pose event based on the pose data;
a serial processing unit configured to perform serialization processing on the pose data and the pose event; and
an information sending unit configured to transmit the pose data and the pose event that are subjected to the serialization processing to a computer device, to cause the computer device to update a virtual object in an extended reality scene based on the pose data and cause a target application running on the computer device to perform a response corresponding to the pose data, where real-time images of the target application are transmitted by the computer device to the extended reality device.

At least one embodiment of the present disclosure provides an electronic device, and the electronic device includes: at least one memory and at least one processor, where the at least one memory is configured to store program codes, and the at least one processor is configured to invoke the program codes stored in the memory to cause the electronic device to perform the pose control method for extended reality according to one or more embodiments of the present disclosure.

At least one embodiment of the present disclosure provides a non-transitory computer storage medium, where the non-transitory computer storage medium stores program codes, and the program codes, when executed by a computer device, cause the computer device to perform the pose control method for extended reality provided according to one or more embodiments of the present disclosure.

According to one or more embodiments of the present disclosure, the pose data of the user and the corresponding pose event sent by the extended reality device are acquired at the computer device, and the virtual object in the extended reality scene is controlled based on the pose data and the target application is caused to perform the response corresponding to the pose event, so that the user can be allowed to perform somatosensory interaction control in an application scenario of extended reality streaming.

### BRIEF DESCRIPTION OF DRAWINGS

The above and other features, advantages, and aspects of the embodiments of the present disclosure will become more apparent when taken in conjunction with the drawings and with reference to the following detailed description. Throughout the drawings, the same or similar reference numbers refer to the same or similar elements. It should be understood that the drawings are schematic and that parts and elements are not necessarily drawn to scale.

FIG. 1 is a schematic flowchart of a pose control method for extended reality provided by embodiments of the present disclosure;

FIG. 2 is a schematic flowchart for updating a virtual object component provided by embodiments of the present disclosure;

FIG. 3 is a schematic flowchart of a pose control method for extended reality provided by other embodiments of the present disclosure;

FIG. 4 is a signal flow diagram between an extended reality device and a computer device provided by embodiments of the present disclosure;

FIG. 5 is a schematic structural diagram of a pose control apparatus for extended reality provided by embodiments of the present disclosure;

FIG. 6 is a schematic structural diagram of a pose control apparatus for extended reality provided by other embodiments of the present disclosure; and

FIG. 7 is a schematic structural diagram of an electronic device provided by embodiments of the present disclosure.

### DETAILED DESCRIPTION

Embodiments of the present disclosure will be described in more detail below with reference to the drawings. While certain embodiments of the present disclosure are shown in the drawings, it should be understood that the present disclosure may be embodied in various forms and should not be construed as limited to the embodiments set forth herein. Rather, these embodiments are provided for a thorough and complete understanding of the present disclosure. It should be understood that the drawings and embodiments of the present disclosure are only for illustrative purposes and are not intended to limit the scope of protection of the present disclosure.

It should be understood that steps described in implementations of the present disclosure may be performed in different orders and/or in parallel. In addition, implementations may include additional steps and/or omit performing illustrated steps. The scope of the present disclosure is not limited in this respect.

As used herein, the term “include/comprise” and variations thereof are open-ended inclusions, that is, “include/comprise but not limited to”. The term “based on” is “based, at least in part, on”. The term “one embodiment” means “at least one embodiment”. The term “another embodiment” means “at least one additional embodiment”. The term “some embodiments” means “at least some embodiments”. The term “in response to” and related terms refer to a situation where one signal or event is affected to some extent by another signal or event, but not necessarily completely or directly. If event x occurs “in response to” event y, then x may be in response to y directly or indirectly. For example, the occurrence of y may ultimately result in the occurrence of x, but there may be other intermediate events and/or conditions. In other cases, y may not necessarily result in the occurrence of x, and x may occur even if y has not occurred yet. In addition, the term “in response to” may also mean “at least in part in response to”.

The term “determine” broadly encompasses a wide variety of actions and may include acquiring, calculating, computing, processing, deriving, investigating, looking up (e.g., looking up in a table, database or other data structure), exploring, and similar actions, and may also include receiving (e.g., receiving information), accessing (e.g., accessing data in a memory), and similar actions, as well as parsing, selecting, choosing, establishing, and similar actions, etc. Related definitions of other terms will be given in the following description.

It should be noted that concepts such as “first” and “second” mentioned in the present disclosure are only used to distinguish between different apparatuses, modules or units, and are not used to limit the order or interdependence of functions performed by these apparatuses, modules or units.

It should be noted that the modifications of “one” and “a plurality of” mentioned in the present disclosure are illustrative rather than limiting, and those skilled in the art should understand that they should be understood as “one or more” unless the context clearly indicates otherwise.

For the purposes of the present disclosure, the phrase “A and/or B” means (A), (B) or (A and B).

The names of messages or information exchanged between a plurality of apparatuses in implementations of the present disclosure are only used for illustrative purposes, and are not intended to limit the scope of these messages or information.

It should be noted that the step of acquiring the user's personal data mentioned in the present disclosure is performed with the user's authorization, for example, in response to receiving the user's active request, prompt information is sent to the user to explicitly prompt the user that the operation requested to be performed will require the acquisition and use of the user's personal information. Thus, the user can autonomously select whether to provide personal information to software or hardware such as an electronic device, an application, a server or a storage medium that performs the operations of the technical solutions of the present disclosure according to the prompt information. As an optional but non-limiting implementation, the manner of sending the prompt information to the user in response to receiving the user's active request may be, for example, a pop-up window, and the prompt information may be presented in the pop-up window in a text form. In addition, the pop-up window may further carry a selection control for the user to select “agree” or “disagree” to provide personal information to the electronic device. It should be understood that the above process of notifying and acquiring user authorization is only illustrative and does not constitute a limitation on the implementations of the present disclosure, and other manners that meet relevant laws and regulations may also be applied to the implementations of the present disclosure. It should be understood that the data involved in the technical solution (including but not limited to the data itself, the acquisition or use of the data) should comply with the requirements of corresponding laws, regulations and related provisions.

The extended reality device described in the embodiments of the present disclosure may include, but is not limited to, the following types.

A computer-side extended reality device performs related calculations and data output for extended reality functions using a PC side, and an external computer-side extended reality device uses data output by the PC side to achieve an effect of extended reality.

A mobile extended reality device supports setting a mobile terminal (such as a smartphone) in various ways (such as a head-mounted display provided with a dedicated card slot). Through a wired or wireless connection with the mobile terminal, the mobile terminal performs related calculations for extended reality functions and outputs data to the mobile extended reality device, such as watching an extended reality video through an APP of the mobile terminal.

An all-in-one extended reality device is provided with a processor for performing related calculations for virtual functions, and thus has independent extended reality input and output functions, does not need to be connected to a PC side or a mobile terminal, and has a high degree of freedom in use.

Certainly, the form of the extended reality device is not limited to this, and may be further miniaturized or enlarged according to needs.

The extended reality device is provided with a sensor (such as a nine-axis sensor) for attitude detection, which is used to detect an attitude change of the extended reality device in real time. If the user wears the extended reality device, when the attitude of the user's head changes, a real-time attitude of the head will be transmitted to a processor, so as to calculate a gaze point of the user's line of sight in the virtual environment. An image in a three-dimensional model of the virtual environment that is within the user's gaze range (i.e., a virtual field of view) is calculated based on the gaze point and displayed on a display screen, so that the user has an immersive experience as if watching in a real-world environment.

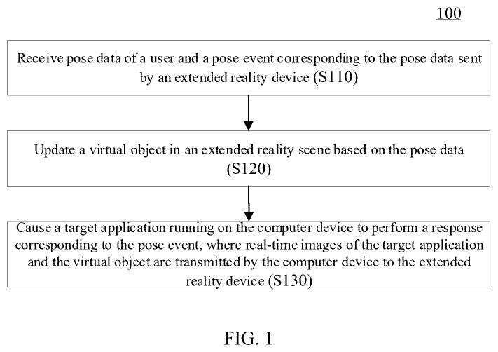

Referring to FIG. 1, it shows a schematic flowchart of a pose control method 100 for extended reality provided by embodiments of the present disclosure. In some embodiments, the method 100 may be performed at a computer device. The computer device (such as a personal computer or a cloud server) transmits extended reality content (such as virtual display, augmented display or mixed reality content), including real-time images, interactive data, etc., to a user's extended reality device (such as a head-mounted display device) for display and interaction in a wired or wireless manner. The method 100 includes steps S110 to S130.

S110: receive pose data of a user and a pose event corresponding to the pose data sent by an extended reality device.

In some embodiments, the pose data may include pose data of a certain body part of the user, including position data and attitude data. The position data may be represented by position coordinates in a three-dimensional Cartesian coordinate system, and the attitude data (such as rotation data) may be represented by a quaternion, Euler angles (such as pitch angle, yaw angle, roll angle), a rotation matrix, or an axis-angle pair, but the present disclosure is not limited thereto.

In some embodiments, the body part of the user corresponding to the pose data may include, but is not limited to, a hand, a foot, a head, an eye, or other body trunk or parts. Typically, the pose data may be gesture data of the user, for example, the extended reality device allows the user to perform interactive control through gestures.

In some embodiments, the pose data may include position and attitude data of respective joints in the body part. Taking a gesture as an example, the gesture data (i.e., the pose data) may include position information and rotation information of a group of joints in a specific hand (such as a left hand or a right hand).

In some embodiments, the pose event is used to cause a system or an application to trigger a predefined response or behavior. Taking a gesture as an example, a gesture recognition system detects a user's gesture action and triggers a corresponding gesture event, after which the application may process these gesture events to perform a corresponding response. A gesture event may be regarded as a description of a gesture action, for example, in an implementation, the gesture event includes an event related to pinching between a thumb and an index finger, touching a palm with a middle finger, pinching between a thumb and a middle finger, or pinching between a thumb and a ring finger; in another implementation, the gesture event includes an event related to an air click, waving, grabbing and releasing, or pinching and stretching, but the present disclosure is not limited thereto.

S120: update a virtual object in an extended reality scene based on the pose data.

In some embodiments, the pose data may be applied to the virtual object in the extended reality scene, so that the virtual object presents a position and an attitude that are consistent with the user's body part corresponding to the pose data. Exemplarily, when the pose data is pose data of a user's hand (for example, the user uses a gesture for human-computer interaction), a hand model (or a model presenting other visual effects) corresponding to the user's hand is displayed in the extended reality scene presented by the extended reality device, and the model has a position and an attitude consistent with those of the user's hand.

In some embodiments, the pose data or data obtained by performing preset processing on the pose data may be sent to a virtual object component (for example, a skeleton component provided by an X R streaming platform), so that the pose data (or the processed pose data) is applied to the virtual object model in the extended reality scene through the virtual object component.

It should be noted that the virtual object may be an object in the target application mentioned below, or may be an object independent of the target application, which is not limited in the present disclosure. In some embodiments, when the virtual object is an object in the target application, an image of the virtual object is contained in an image of the target application; when the virtual object is an object independent of the target application, the computer device transmits not only the real-time images of the target application but also the real-time images of the virtual object to the extended reality device.

S130: cause a target application running on the computer device to perform a response corresponding to the pose event, where real-time images of the target application and the virtual object are transmitted by the computer device to the extended reality device.

In some embodiments, the target application is an application available for X R streaming, which runs on the computer device, and its content is transmitted by the computer device to the extended reality device for display and interaction in a wired or wireless manner.

After acquiring the pose event, the target application may perform an interactive control function corresponding to the pose event, such as triggering an action corresponding to the pose event, inputting corresponding content, and adjusting audio-visual content presented by the target application. Exemplarily, the user may move, turn or adjust a viewing angle in the virtual space through a gesture event, trigger a function of a corresponding control (open a menu, trigger a control) through a gesture or a combination of gestures, interact with a virtual object in the target application (for example, move, grab and release the virtual object), and control visual elements (scroll, zoom interface, etc.) in the target application.

The real-time images and interactive data of the target application (including the real-time images and interactive data of the target application after performing the response corresponding to the pose event) are transmitted by the computer device to the extended reality device in a wired or wireless manner for presentation to the user.

According to one or more embodiments of the present disclosure, the pose data of the user and the corresponding pose event sent by the extended reality device are acquired at the computer device, and the virtual object in the extended reality scene is controlled based on the pose data and the target application is caused to perform the response corresponding to the pose event, so that the user can be allowed to perform pose-based somatosensory interaction control in an application scenario of extended reality streaming.

In some embodiments, S120 may include:
A1: transform the pose data into target pose data, where the target pose data includes position data and attitude data of joints at different hierarchical levels, the position data of a child joint is data of a position of the child joint relative to a parent joint of the child joint, and the attitude data of the child joint is data of an attitude of the child joint relative to the parent joint of the child joint;
A2: update the virtual object based on the target pose data.

Exemplarily, a relative position vector of the child joint relative to the parent joint may be obtained by subtracting a global coordinate value of the child joint from a global coordinate value of the parent joint and used as the position data of the child joint; and an inverse operation is performed on a rotation of the parent joint in a global coordinate system, and an obtained inverse matrix or inverse quaternion is compounded with a rotation of the child joint in its local coordinate system by multiplication (such as matrix multiplication or quaternion multiplication) to obtain rotation data of the child joint relative to the parent joint.

In the present embodiment, the position and rotation of the child joint are transformed into the position and rotation relative to the parent joint, so that a hierarchical relationship is formed between the joints, thereby maintaining the consistency and linkage of the overall skeleton structure.

In some embodiments, when the attitude data corresponds to a hand of the user, the target pose data further includes auxiliary position data and auxiliary attitude data corresponding to each finger, where the auxiliary position data includes data of a position of a terminal joint of the finger relative to a root joint of the hand, and the auxiliary attitude data includes data of an attitude of the terminal joint of the finger relative to the root joint of the hand. In a detailed implementation, the terminal joint of the finger may include a fingertip, and the root joint of the hand may include a wrist joint or a center of a palm, but the present disclosure is not limited thereto.

In the present embodiment, the auxiliary position data and the auxiliary attitude data corresponding to each finger may be used to enable the gesture recognition system to more accurately capture and understand complex motion information of the hand, enhance the understanding and reproduction ability of the hand motion, and improve the predictability of the gesture interaction.

In some embodiments, when the detection frequency of the pose data is lower than the data update frequency required to update the virtual object, interpolation processing is performed on the pose data to generate pose data whose frequency is consistent with the data update frequency, thereby solving the problem of the mismatch between the detection frequency of the gesture data and the update frequency of the virtual object. Exemplarily, an ordered container (such as a binary search tree) may be used to store and retrieve gesture data corresponding to time stamps, and then interpolation calculation is performed according to the current time and a target frame rate (for example, the data update frequency of the virtual object). For example, a binary tree search tree or other ordered container for storing gesture data is constructed, where a key is time, and a value is gesture data; gesture data acquired at the nth millisecond is cached in the ordered container, and for each acquisition of new gesture data, an acquisition time of the new gesture data is subtracted by n milliseconds to obtain a key corresponding to the gesture data, which is inserted into the ordered container, then adjacent elements are taken for interpolation, and the above process is repeated to obtain gesture data with the target frame rate. In some embodiments, expired data may also be cleared during the interpolation processing, and the time and space complexity of the interpolation algorithm may be controlled.

In some embodiments, S140 may further include: determining an interactor event corresponding to the pose event, and causing the target application to perform a response corresponding to the interactor event.

An interactor is a human-computer interaction device for realizing communication or interaction between the user and the electronic device, including but not limited to a device such as a handle, a joystick, a steering wheel, a mouse, a keyboard, a trackball, etc. The interactor event includes a software-recognizable event triggered by a user input behavior related to the interaction device. For example, when the user presses a certain button on the handle, pulls a joystick, or triggers various sensors (such as an accelerometer and a gyroscope) built in the handle, these operations will be detected by the hardware of the handle and converted into digital signals, and then transmitted to a computer or other electronic devices through an interface.

In some embodiments, a mapping relationship between the pose event and the interactor event is predefined, and the mapping relationship may be used to determine the interactor event corresponding to the pose event. Different pose events may correspond to different interactor events. For example, when the gesture event is an event related to pinching between the thumb and the index finger, the handle event that is mapped may be an event related to Button A; when the gesture event is an event related to touching the palm with the middle finger, the handle event that is mapped may be an event related to Button B. In this way, the pose event of the user is mapped to the interactor event, so that the pose-based somatosensory interaction mode is effectively compatible with the X R streaming application or platform that adopts the human-machine device interaction mode.

In an implementation, after obtaining the interactor event corresponding to the pose event, the interactor event may be sent to an interactor component provided by the X R streaming platform, so that the target application performs the response corresponding to the pose event, thereby realizing the simulation of the operation of the interactor.

In some embodiments, in response to there being no interactor event corresponding to the pose event that is acquired, the pose event may be delivered to the target application. In the present embodiment, for a pose event that is not mapped to an interactor event, the pose event may be directly transmitted to the target application through a predefined input component, and the application itself implements the response to the pose event.

In some embodiments, before the pose data is transformed into the target pose data, the following steps may be performed:
B1: determine whether there is a registered interactor currently;
B2: perform step of transforming the pose data into the target pose data in response to determining that there is no registered interactor currently or in response to determining that there is no data input to the registered interactor within a recent preset time period (e.g., within the last 300 ms).

Some X R streaming applications or platforms support controlling the virtual object through a human-computer interaction device (such as a handle). Then, after the manner of performing interactive control by introducing the pose data of the user acquired by the sensor, there may be a case where the virtual object is controlled based on both the human-computer interaction device and the pose data, which easily leads to the problem that the above two interaction manners conflict with each other. In this regard, according to one or more embodiments of the present disclosure, it is determined whether there is a registered interactor currently before the pose data is transformed into the target pose data, and the pose data is transformed into the target pose data for controlling the virtual object in response to determining that there is no registered interactor currently or in response to determining that there is no data input to the registered interactor within the recent preset time period, so that the conflict between different interactive control manners can be prevented.

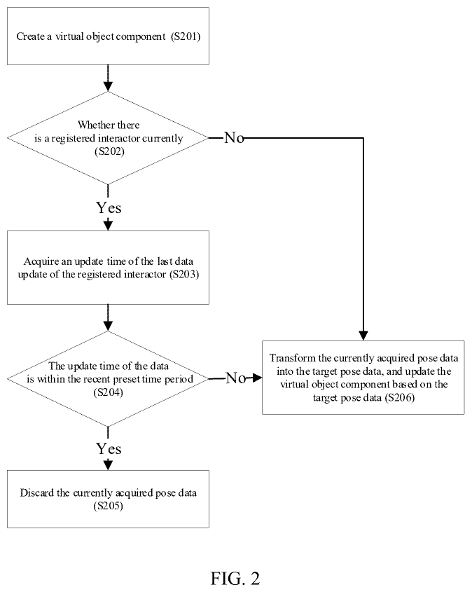

Referring to FIG. 2, it shows a method for updating a virtual object component, including 201 to 206.

S201, create a virtual object component. The virtual object component is used to drive a virtual object model (such as a hand model) based on the pose data to dynamically update the attitude of the model.

S202, query whether there is a registered interactor currently. In response to there being a registered interactor currently, S203 is performed; in response to there being no registered interactor currently, S206 is performed.

S203, acquire an update time of the last data update of the registered interactor.

S204, confirm whether the update time of the data is within the recent preset time period.

When the update time is within the recent preset time period, it may be considered that the interactor data is being updated, and S205 may perform: discard the currently acquired pose data.

When the update time is not within the recent preset time period, and S206 may perform: transform the currently acquired pose data into the target pose data, and update the virtual object component based on the target pose data.

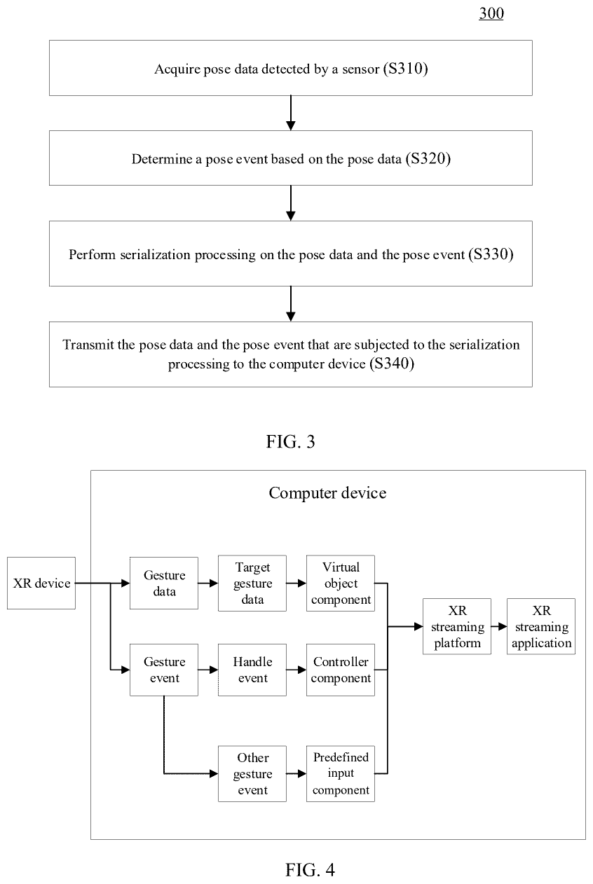

Referring to FIG. 3, it shows a schematic flowchart of a pose control method 300 for extended reality provided by embodiments of the present disclosure. In some embodiments, the method 300 may be performed at an extended reality device (such as a head-mounted display device) in communication with a computer device (such as a personal computer or a cloud server). The computer device transmits extended reality contents (such as virtual display, augmented display or mixed reality content), including real-time images, interactive data, etc., to the user's extended reality device for display and interaction in a wired or wireless manner.

The method 300 includes S310 to S340.

S310: acquire pose data detected by a sensor.

The extended reality device may be integrated with a display generation component (such as a display screen) and communicate with one or more sensors (such as an eye tracking device, a hand tracking device, or a camera), and the sensors may be integrated in or external to the extended reality device.

In some embodiments, the sensor may detect the attitude data based on a detection manner of motion sensing or a detection manner of computer vision. For example, the pose of a certain body part (such as a hand) of the user may be detected by a motion tracking algorithm based on computer vision based on a camera (such as a depth camera), or the pose (such as six-degree-of-freedom data) of the body part may be detected by a tracking device (such as a handheld controller) held or worn on the body part, but the present disclosure is not limited thereto. The six degrees of freedom include three translational degrees of freedom in directions of x, y and z rectangular coordinate axes and three rotational degrees of freedom about the three coordinate axes, i.e., front-rear, up-down, left-right, pitch, yaw and roll, for a total of six degrees of freedom.

In some embodiments, the extended reality device is integrated with a hand tracking device, through which hand information of the user, such as a gesture of the user, may be acquired. The hand tracking device is part of the extended reality device (for example, it is embedded in or attached to a head-mounted device).

In some implementations, the hand tracking device includes an image sensor (e.g., one or more infrared cameras, 3D cameras, depth cameras, and/or color cameras, etc.) that captures three-dimensional scene information that includes at least a human user's hand. The image sensor captures images of the hand at a sufficient resolution to enable fingers and their respective positions to be discerned.

In some implementations, the hand tracking device captures and processes a time sequence of depth maps containing the user's hand as the user moves his or her hand (e.g., the entire hand or one or more fingers). Software running on the image sensor and a processor of the HM D processes the 3D mapping data to extract image block descriptors of the hand in these depth maps. The software may match these descriptors with image block descriptors stored in a database based on a previous learning process, in order to estimate the pose of the hand in each frame. The pose generally includes 3D positions of joints of the user's hand and fingertips. The software may also analyze the trajectory of the hand and/or fingers over a plurality of frames in the sequence to recognize gestures. The pose estimation function described herein may alternate with the motion tracking function, such that the image block-based pose estimation is performed only once every two (or more) frames, while the tracking is used to find the changes in pose that occur over the remaining frames, and provide pose, motion, and gesture information to the application running on the HM D. The program may, for example, move and modify images presented on the HM D display generation component in response to pose and/or gesture information, or perform other functions, such as executing control instructions corresponding to gestures and the like.

In some embodiments, the HM D is integrated with a gaze tracking device, through which visual information of the user, such as the user's line of sight, a gaze point, etc., may be acquired. In some embodiments, the gaze tracking device includes at least one eye tracking camera (e.g., an infrared (IR) or near infrared (NIR) camera), and an illumination source (e.g., an infrared or near infrared light source, such as an array or ring of LEDs) that emits light (e.g., infrared or near infrared light) toward the user's eyes. The eye tracking camera may be directed at the user's eyes to receive infrared or near infrared light directly reflected from the eyes by the light source, or alternatively may be directed at “hot” mirrors located between the user's eyes and the display panel, which reflect the infrared or near infrared light from the eyes to the eye tracking camera while allowing visible light to pass through. The gaze tracking device optionally captures images of the user's eyes (e.g., as a video stream captured at 60-120 frames per second (fps)), analyzes these images to generate gaze tracking information, and transmits the gaze tracking information to the HM D, so that some human-computer interaction functions may be completed based on the user's gaze information, such as performing content navigation based on the gaze information. In some implementations, both eyes of the user are tracked separately through respective eye tracking cameras and illumination sources. In some implementations, only one of the user's eyes is tracked through a respective eye tracking camera and illumination source.

S320: determine a pose event based on the pose data.

In some embodiments, the extended reality device performs preprocessing steps such as filtering and smoothing on the data detected by the sensor and inputs the preprocessed data into a pose recognition algorithm to determine the type of the current pose, thereby obtaining the corresponding pose event. The pose recognition algorithm may include, but is not limited to, template matching, a machine learning model (such as a classification algorithm such as a decision tree, a support vector machine, and a naive Bayes), a deep learning algorithm (such as a convolutional neural network), a hidden Markov model, etc.

S330: perform serialization processing on the pose data and the pose event.

In the present step, the gesture data and the gesture event acquired by the extended reality device are subjected to the serialization processing, and converted into a linear and orderly data stream, which is convenient for relevant data to be streamed between the extended reality device and the computer device. In an implementation, a platform-independent data serialization protocol (such as protobuf protocol) may be used to perform the serialization processing on the pose data and the pose event, so that the processed data can be adapted to different platforms or languages.

S340: transmit the pose data and the pose event that are subjected to the serialization processing to the computer device, to cause the computer device to update a virtual object in an extended reality scene based on the pose data and cause a target application running on the computer device to perform a response corresponding to the pose data, where real-time images of the target application are transmitted by the computer device to the extended reality device.

According to one or more embodiments of the present disclosure, the pose data detected by the sensor is acquired at the extended reality device in communication with the computer device, the corresponding pose event is determined, the pose data and the pose event are subjected to the serialization processing and sent to the computer device to cause the computer device to perform the corresponding response, so that the user can be allowed to perform the somatosensory interaction control in the application scenario of extended reality streaming.

Referring to FIG. 4, it shows a signal flow between the extended reality device and the computer device. An XR streaming platform and an X R streaming application run on the computer device. The extended reality device acquires gesture data through its own sensor and generates a gesture event corresponding to the gesture data, performs serialization on the gesture data and the gesture event, and transmits the gesture data and the gesture event to the computer device in a wired or wireless manner. At the computer device, the gesture data may be transformed into target gesture data through a driver, and the virtual object component is updated based on the target gesture data to control the X R streaming application on the X R streaming platform. Synchronously, the computer device maps the gesture event to a handle event (such as a handle button event) through a driver and transmits these handle events to a controller component, so that the X R streaming application performs the corresponding response by simulating pressing of the handle button. For a gesture event that cannot be mapped to a handle event (“other gesture event”), it may be directly transmitted to the X R streaming application through a predefined input component for processing by the X R streaming application itself.

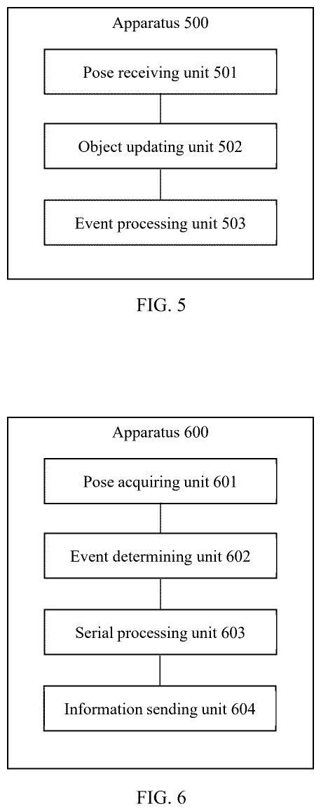

Correspondingly, referring to FIG. 5, a pose control apparatus 500 for extended reality is provided by embodiments of the present disclosure, including:
a pose receiving unit 501 configured to receive pose data of a user and a pose event corresponding to the pose data sent by the extended reality device;
an object updating unit 502 configured to update a virtual object in an extended reality scene based on the pose data; and
an event processing unit 503 configured to cause a target application running on the computer device to perform a response corresponding to the pose event, where real-time images of the target application are transmitted by the computer device to the extended reality device.

In some embodiments, the object updating unit 502 includes:
a data transforming sub-unit configured to transform the pose data into target pose data, where the target pose data includes position data and attitude data of joints at different hierarchical levels, the position data of a child joint is data of a position of the child joint relative to a parent joint of the child joint, and the attitude data of the child joint is data of an attitude of the child joint relative to the parent joint of the child joint; and
an object updating sub-unit configured to update the virtual object based on the target pose data.

In some embodiments, in response to the attitude data corresponding to a hand of the user, the target pose data further includes auxiliary position data and auxiliary attitude data corresponding to each finger, where the auxiliary position data includes data of a position of a terminal joint of the finger relative to a root joint of the hand, and the auxiliary attitude data includes data of an attitude of the terminal joint of the finger relative to the root joint of the hand.

In some embodiments, the pose control apparatus 500 further includes:
an interactor determining unit configured to determine whether there is a registered interactor currently; and
the data transforming sub-unit is further configured to: perform step of transforming the pose data into the target pose data in response to determining that there is no registered interactor currently or in response to determining that there is no data input to the registered interactor within a recent preset time period.

In some embodiments, the pose control apparatus 500 further includes:
an interpolation processing unit configured to, in response to a detection frequency of the pose data being lower than a data update frequency required to update the virtual object, perform interpolation processing on the pose data to generate pose data whose frequency is consistent with the data update frequency.

In some embodiments, the event processing unit 503 is further configured to determine an interactor event corresponding to the pose event, and cause the target application to perform a response corresponding to the interactor event.

In some embodiments, the event processing unit 503 is further configured to, deliver the pose event to the target application in response to there being no interactor event corresponding to the pose event.

According to one or more embodiments of the present disclosure, the pose data and the pose event are data that is subjected to the serialization processing by the extended reality device.

Correspondingly, referring to FIG. 6, a pose control apparatus 600 for extended reality is provided by embodiments of the present disclosure, including:
a pose acquiring unit 601 configured to acquire pose data detected by a sensor;
an event determining unit 602 configured to determine a pose event based on the pose data;
a serial processing unit 603 configured to perform serialization processing on the pose data and the pose event; and
an information sending unit 604 configured to transmit the pose data and the pose event that are subjected to the serialization processing to a computer device, to cause the computer device to update a virtual object in an extended reality scene based on the pose data and cause a target application running on the computer device to perform a response corresponding to the pose data, where real-time images of the target application are transmitted by the computer device to the extended reality device.

In some embodiments, the pose control apparatus 600 further includes:
an interpolation processing unit configured to, in response to a detection frequency of the pose data being lower than data update frequency required to update the virtual object, perform interpolation processing on the pose data to generate pose data whose frequency is consistent with the data update frequency.

For the apparatus embodiments, since they basically correspond to the method embodiments, reference may be made to the description of the method embodiments for related parts. The apparatus embodiments described above are only illustrative, and the modules described as separate modules may or may not be separated. Some or all of the modules may be selected according to actual needs to achieve the purposes of the solutions of the embodiments. Those of ordinary skill in the art can understand and implement them without creative effort.

Correspondingly, one or more embodiments of the present disclosure provide an electronic device, and the electronic device includes:
at least one memory and at least one processor;
where the at least one memory is configured to store program codes, and the at least one processor is configured to invoke the program codes stored in the memory to cause the electronic device to perform the pose control method for extended reality provided according to the one or more embodiments of the present disclosure.

Accordingly, one or more embodiments of the present disclosure provide a non-transitory computer storage medium, where the non-transitory computer storage medium stores program codes, and the program codes may be executed by a computer device to cause the computer device to perform the pose control method for extended reality provided according to one or more embodiments of the present disclosure.

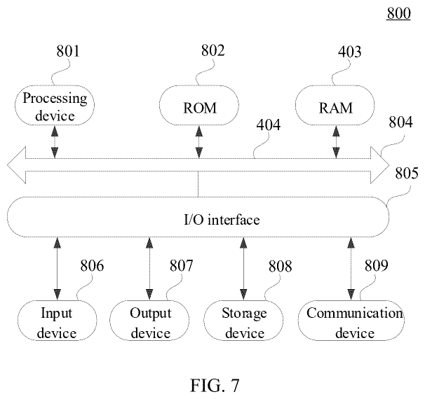

Referring to FIG. 7 below, it shows a schematic structural diagram of an electronic device 800 suitable for implementing embodiments of the present disclosure. The electronic device shown in FIG. 7 is only an example, and should not bring any limitations to the function and scope of use of the embodiments of the present disclosure.

As shown in FIG. 7, the electronic device 800 may include a processing apparatus (such as a central processing unit, a graphics processor, etc.) 801, which may perform various suitable actions and processing according to a program stored in a read-only memory (ROM) 802 or a program loaded from a storage unit 808 into a random access memory (RAM) 803. The RAM 803 also stores various programs and data required for the operation of the electronic device 800. The processing apparatus 801, the ROM 802, and the RAM 803 are connected to each other through a bus 804. An input/output (I/O) interface 805 is also connected to the bus 804.

Generally, the following apparatuses may be connected to the I/O interface 805: an input apparatus 806 including, for example, a touchscreen, a touchpad, a keyboard, a mouse, a camera, a microphone, an accelerometer, a gyroscope, etc.; an output apparatus 807 including, for example, a liquid crystal display (LCD), a speaker, a vibrator, etc.; a storage apparatus 808 including, for example, a magnetic tape, a hard disk, etc.; and a communication apparatus 809. The communication apparatus 809 may allow the electronic device 800 to perform wireless or wired communication with other devices to exchange data. Although FIG. 7 shows the electronic device 800 having various apparatuses, it should be understood that it is not required to implement or have all of the illustrated apparatuses. M ore or fewer apparatuses may alternatively be implemented or provided.

In particular, according to the embodiments of the present disclosure, the processes described above with reference to the flowcharts may be implemented as computer software programs. For example, the embodiments of the present disclosure include a computer program product, which includes a computer program carried on a computer-readable medium, and the computer program includes program codes for executing the methods shown in the flowcharts. In such an embodiment, the computer program may be downloaded and installed from the network through the communication apparatus 809, or may be installed from the storage unit 808, or may be installed from the ROM 802. When the computer program is executed by the processing apparatus 801, the above functions defined in the methods of the embodiments of the present disclosure are executed.

It should be noted that the computer-readable medium described above in the present disclosure may be a computer-readable signal medium or a computer-readable storage medium or any combination thereof. The computer-readable storage medium may be, for example, but not limited to, an electrical, magnetic, optical, electromagnetic, infrared, or semiconductor system, apparatus or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program that may be used by or in conjunction with an instruction execution system, apparatus or device. In the present disclosure, the computer-readable signal medium may include a data signal that propagates in a baseband or as a part of a carrier, and carries computer-readable program codes therein. The data signal propagating in this manner may be in various forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in conjunction with an instruction execution system, apparatus or device. The program codes contained on the computer-readable medium may be transmitted by any suitable medium, including but not limited to an electric wire, an optical cable, a radio frequency (RF), etc., or any suitable combination thereof.

In some implementations, clients and servers may communicate using any currently known or future developed network protocol such as the Hypertext transfer protocol (HTTP), and may be interconnected with any form or medium of digital data communication (for example, a communication network). Examples of the communication network include a local area network (“LAN”), a wide area network (“WAN”), an internet (for example, the Internet), and a peer-to-peer network (for example, an ad hoc network), as well as any currently known or future developed network.

The above computer-readable medium may be included in the above electronic device, or may exist alone without being assembled into the electronic device.

The above computer-readable medium carries one or more programs which, when executed by the electronic device, cause the electronic device to execute the above method of the present disclosure.

The computer program codes for performing the operations of the present disclosure may be written in one or more programming languages or a combination thereof. The above programming languages include object-oriented programming languages such as Java, Smalltalk, C++, and also conventional procedural programming languages such as the “C” programming language or similar programming languages. The program codes may be executed entirely on a user's computer, partly on a user's computer, as a stand-alone software package, partly on a user's computer and partly on a remote computer, or entirely on a remote computer or a server. In the scenario related to the remote computer, the remote computer may be connected to the user's computer through any kind of network, including a local area network (LAN) or a wide area network (WAN), or the connection may be made to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, program segment, or portion of codes, including one or more executable instructions for implementing specified logical functions. It should also be noted that, in some alternative implementations, the functions noted in the blocks may occur out of the order noted in the drawings. For example, two blocks shown in succession may, in fact, be executed substantially concurrently, or the blocks may sometimes be executed in the reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments described in the present disclosure may be implemented in software or hardware. The name of a unit does not constitute a limitation of the unit itself under certain circumstances.

The functions described herein above may be performed, at least in part, by one or more hardware logic components. For example, without limitation, available exemplary types of hardware logic components include: a field programmable gate array (FPGA), an application specific integrated circuit (A SIC), an application specific standard product (ASSP), a system on chip (SOC), a complex programmable logical device (CPLD), etc.

In the context of the present disclosure, the machine-readable medium may be a tangible medium that may contain or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection with one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

According to one or more embodiments of the present disclosure, a pose control method for extended reality, which is performed by a computer device in communication with an extended reality device is provided, including: receiving pose data of a user and a pose event corresponding to the pose data sent by the extended reality device; updating a virtual object in an extended reality scene based on the pose data; and causing a target application running on the computer device to perform a response corresponding to the pose event, where real-time images of the target application are transmitted by the computer device to the extended reality device.

According to one or more embodiments of the present disclosure, updating the virtual object in the extended reality scene based on the pose data includes: transforming the pose data into target pose data, where the target pose data includes position data and attitude data of joints at different hierarchical levels, the position data of a child joint is data of a position of the child joint relative to a parent joint of the child joint, and the attitude data of the child joint is data of an attitude of the child joint relative to the parent joint of the child joint; and updating the virtual object based on the target pose data.

According to one or more embodiments of the present disclosure, in response to the attitude data corresponding to a hand of the user, the target pose data further includes auxiliary position data and auxiliary attitude data corresponding to each finger, where the auxiliary position data includes data of a position of a terminal joint of the finger relative to a root joint of the hand, and the auxiliary attitude data includes data of an attitude of the terminal joint of the finger relative to the root joint of the hand.

According to one or more embodiments of the present disclosure, before transforming the pose data into the target pose data, the method further includes: determining whether there is a registered interactor currently; and performing step of transforming the pose data into the target pose data in response to determining that there is no registered interactor currently or in response to determining that there is no data input to the registered interactor within a recent preset time period.

According to one or more embodiments of the present disclosure, the method further includes: in response to a detection frequency of the pose data being lower than a data update frequency required to update the virtual object, performing interpolation processing on the pose data to generate pose data whose frequency is consistent with the data update frequency.

According to one or more embodiments of the present disclosure, causing the target application running on the computer device to perform the response corresponding to the pose event includes: determining an interactor event corresponding to the pose event, and causing the target application to perform a response corresponding to the interactor event.

According to one or more embodiments of the present disclosure, causing the target application running on the computer device to perform the response corresponding to the pose event includes: delivering the pose event to the target application in response to there being no interactor event corresponding to the pose event.

According to one or more embodiments of the present disclosure, the pose data and the pose event are data that is subjected to serialization processing by the extended reality device.

According to one or more embodiments of the present disclosure, a pose control method for extended reality performed by an extended reality device in communication with a computer device is provided, including: acquiring pose data detected by a sensor; determining a pose event based on the pose data; performing serialization processing on the pose data and the pose event; and transmitting the pose data and the pose event that are subjected to the serialization processing to the computer device, to cause the computer device to update a virtual object in an extended reality scene based on the pose data and cause a target application running on the computer device to perform a response corresponding to the pose data, where real-time images of the target application are transmitted by the computer device to the extended reality device.

According to one or more embodiments of the present disclosure, the method further includes: in response to a detection frequency of the pose data being lower than data update frequency required to update the virtual object, performing interpolation processing on the pose data to generate pose data whose frequency is consistent with the data update frequency.

According to one or more embodiments of the present disclosure, a pose control apparatus for extended reality is provided, including: a pose receiving unit configured to receive pose data of a user and a corresponding pose event sent by the extended reality device; an object updating unit configured to update a virtual object in an extended reality scene based on the pose data; and an event processing unit configured to cause a target application running on the computer device to perform a response corresponding to the pose event, where real-time images of the target application are transmitted by the computer device to the extended reality device.

According to one or more embodiments of the present disclosure, a pose control apparatus for extended reality is provided, including: a pose receiving unit configured to receive pose data of a user and a pose event corresponding to the pose data sent by an extended reality device; an object updating unit configured to update a virtual object in an extended reality scene based on the pose data; and an event processing unit configured to cause a target application running on a computer device to perform a response corresponding to the pose event, where real-time images of the target application are transmitted by the computer device to the extended reality device.

According to one or more embodiments of the present disclosure, an electronic device is provided, including: at least one memory and at least one processor; where the at least one memory is configured to store program codes, and the at least one processor is configured to invoke the program codes stored in the memory to cause the electronic device to perform the pose control method for extended reality provided according to one or more embodiments of the present disclosure.

According to one or more embodiments of the present disclosure, a non-transitory computer storage medium is provided, where the non-transitory computer storage medium stores program codes, and the program codes, when executed by a computer device, cause the computer device to perform the pose control method for extended reality provided according to one or more embodiments of the present disclosure.

The above description is only preferred embodiments of the present disclosure and an illustration of the applied technical principles. Those skilled in the art should understand that the scope of disclosure involved in the present disclosure is not limited to the technical solutions formed by the specific combination of the above technical features, and should also cover other technical solutions formed by any combination of the above technical features or equivalent features thereof without departing from the above disclosed concept. For example, a technical solution formed by replacing the above features with technical features with similar functions disclosed in the present disclosure (but not limited to).

In addition, although operations are depicted in a particular order, this should not be understood as requiring these operations to be performed in the specific order shown or in a sequential order. Under certain circumstances, multitasking and parallel processing may be advantageous. Likewise, although the above discussion contains several specific implementation details, these should not be construed as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or method logical actions, it should be understood that the subject matter defined in the appended claims is not necessarily limited to the specific features or actions described above. Rather, the specific features and actions described above are merely example forms of implementing the claims.

1. A pose control method for extended reality, performed by a computer device in communication with an extended reality device, wherein the method comprises:
receiving pose data of a user and a pose event corresponding to the pose data sent by the extended reality device;
updating a virtual object in an extended reality scene based on the pose data; and
causing a target application running on the computer device to perform a response corresponding to the pose event, wherein real-time images of the target application are transmitted by the computer device to the extended reality device.

2. The method according to claim 1, wherein updating the virtual object in the extended reality scene based on the pose data comprises:
transforming the pose data into target pose data, wherein the target pose data comprises position data and attitude data of joints at different hierarchical levels, the position data of a child joint is data of a position of the child joint relative to a parent joint of the child joint, and the attitude data of the child joint is data of an attitude of the child joint relative to the parent joint of the child joint; and
updating the virtual object based on the target pose data.

3. The method according to claim 2, wherein in response to the attitude data corresponding to a hand of the user, the target pose data further comprises auxiliary position data and auxiliary attitude data corresponding to each finger,
wherein the auxiliary position data comprises data of a position of a terminal joint of the finger relative to a root joint of the hand, and the auxiliary attitude data comprises data of an attitude of the terminal joint of the finger relative to the root joint of the hand.

4. The method according to claim 1, wherein before transforming the pose data into the target pose data, the method further comprises:
determining whether there is a registered interactor currently; and
performing step of transforming the pose data into the target pose data in response to determining that there is no registered interactor currently or in response to determining that there is no data input to the registered interactor within a recent preset time period.

5. The method according to claim 1, further comprising:
in response to a detection frequency of the pose data being lower than a data update frequency required to update the virtual object, performing interpolation processing on the pose data to generate pose data whose frequency is consistent with the data update frequency.

6. The method according to claim 1, wherein causing the target application running on the computer device to perform the response corresponding to the pose event comprises:
determining an interactor event corresponding to the pose event, and causing the target application to perform a response corresponding to the interactor event.

7. The method according to claim 6, wherein causing the target application running on the computer device to perform the response corresponding to the pose event comprises:
delivering the pose event to the target application in response to there being no interactor event corresponding to the pose event.

8. The method according to claim 1, wherein the pose data and the pose event are data that is subjected to serialization processing by the extended reality device.

9. A pose control method for extended reality, performed by an extended reality device in communication with a computer device, wherein the method comprises:
acquiring pose data detected by a sensor;
determining a pose event based on the pose data;
performing serialization processing on the pose data and the pose event; and
transmitting the pose data and the pose event that are subjected to the serialization processing to the computer device, to cause the computer device to update a virtual object in an extended reality scene based on the pose data and cause a target application running on the computer device to perform a response corresponding to the pose data, wherein real-time images of the target application are transmitted by the computer device to the extended reality device.

10. The method according to claim 9, further comprising:
in response to a detection frequency of the pose data being lower than data update frequency required to update the virtual object, performing interpolation processing on the pose data to generate pose data whose frequency is consistent with the data update frequency.

11. An electronic device, comprising:
at least one memory and at least one processor;
wherein the at least one memory is configured to store program codes, and the at least one processor is configured to invoke the program codes stored in the at least one memory to cause the electronic device to perform a pose control method for extended reality, the method is performed by a computer device in communication with an extended reality device, and the method comprises:
receiving pose data of a user and a pose event corresponding to the pose data sent by the extended reality device;
updating a virtual object in an extended reality scene based on the pose data; and
causing a target application running on the computer device to perform a response corresponding to the pose event, wherein real-time images of the target application are transmitted by the computer device to the extended reality device.

12. The electronic device according to claim 11, wherein updating the virtual object in the extended reality scene based on the pose data comprises:
transforming the pose data into target pose data, wherein the target pose data comprises position data and attitude data of joints at different hierarchical levels, the position data of a child joint is data of a position of the child joint relative to a parent joint of the child joint, and the attitude data of the child joint is data of an attitude of the child joint relative to the parent joint of the child joint; and
updating the virtual object based on the target pose data.

13. The electronic device according to claim 12, wherein in response to the attitude data corresponding to a hand of the user, the target pose data further comprises auxiliary position data and auxiliary attitude data corresponding to each finger,
wherein the auxiliary position data comprises data of a position of a terminal joint of the finger relative to a root joint of the hand, and the auxiliary attitude data comprises data of an attitude of the terminal joint of the finger relative to the root joint of the hand.

14. The electronic device according to claim 11, wherein before transforming the pose data into the target pose data, the method further comprises:
determining whether there is a registered interactor currently; and
performing the step of transforming the pose data into the target pose data in response to determining that there is no registered interactor currently or in response to determining that there is no data input to the registered interactor within a recent preset time period.

15. The electronic device according to claim 11, further comprising:
in response to a detection frequency of the pose data being lower than a data update frequency required to update the virtual object, performing interpolation processing on the pose data to generate pose data whose frequency is consistent with the data update frequency.

16. The electronic device according to claim 11, wherein causing the target application running on the computer device to perform the response corresponding to the pose event comprises:
determining an interactor event corresponding to the pose event, and causing the target application to perform a response corresponding to the interactor event.

17. The electronic device according to claim 16, wherein causing the target application running on the computer device to perform the response corresponding to the pose event comprises:
delivering the pose event to the target application in response to there being no interactor event corresponding to the pose event.

18. An electronic device, comprising:
at least one memory and at least one processor;
wherein the at least one memory is configured to store program codes, and the at least one processor is configured to invoke the program codes stored in the at least one memory to cause the electronic device to perform the method according to claim 9.

19. A non-transitory computer storage medium, wherein
the non-transitory computer storage medium stores program codes, the program codes, when executed by a computer device, cause the computer device to perform the method according to claim 1.

20. A non-transitory computer storage medium, wherein
the non-transitory computer storage medium stores program codes, the program codes, when executed by a computer device, cause the computer device to perform the method according to claim 9.
